(19) United States
(12) Patent Application Publication
(10) Pub. No.: US 2016/0202909 A1
(43) Pub. Date: Jul. 14, 2016

(54) I/O SCHEDULING METHOD USING READ PRIORITIZATION TO REDUCE APPLICATION DELAY

(71) Applicant: College of William and Mary, Williamsburg, VA (US)

(72) Inventors: Dung Nguyen Tien, Newport News, VA (US); Gang Zhou, Williamsburg, VA (US)

(21) Appl. No.: 14/989,321

(22) Filed: Jan. 6, 2016

Related U.S. Application Data
(60) Provisional application No. 62/103,120, filed on Jan. 14, 2015.

(51) Int. Cl. G06F 3/06

(52) U.S. Cl. CPC G06F 3/061; G06F 3/0604; G06F 3/064; G06F 3/0679

(57) ABSTRACT

An I/O scheduler having reduced application delay is provided for an electronic device having storage media and running at least one application. Each application interfaces with the storage media through an I/O path. Each application issues I/O requests requiring access to the storage media. The I/O requests include reads from the storage media and writes to the storage media. The I/O requests are ordered in the I/O path such that the reads are assigned a higher priority than the writes. The I/O requests are dispatched from the I/O path to the storage media in accordance with ordering step such that the reads are dispatched before the writes. The scheduler's dispatch can also apply concurrency parameters for the electronic device.

### CROSS-REFERENCE TO RELATED APPLICATIONS

Pursuant to 35 U.S.C. §119, the benefit of priority from provisional application Ser. No. 62/103,120, with a filing date of Jan. 14, 2015, is claimed for this non-provisional application.

### STATEMENT REGARDING FEDERALLY SPONSORED RESEARCH OR DEVELOPMENT

This invention was made with government support under Grant No. CNS-1250180 awarded by the National Science Foundation. The government has certain rights in the invention.

### FIELD OF INVENTION

The field of the invention relates generally to input/output (I/O) scheduling on smartphones, tablets and other electronic communication devices, and more particularly to an I/O scheduling method that prioritizes read operations ahead of write operations in order to reduce delays associated with application launches and delays occurring during application run-time.

### BACKGROUND OF THE INVENTION

The number of smartphones and computer tablets used worldwide increases each year. Moreover, smartphone and tablet users are increasingly using their devices for work-related activities including processing emails, reading and revising documents, etc. As reliance on these types of electronic devices increases, so does an expectation of improved performance. In particular, reducing application time delays (that typically occur during the launch of an application) can greatly improve user productivity. Many user interactions with smartphones are short in duration, and many smartphone/tablet applications are used for less than a couple of minutes. With such brief interactions, application launches need to be rapid and responsive. However, many applications (or “apps” as they are also well-known) incur significant time delays (e.g., up to 10 seconds) during launch and run-time. See, for example, T. Yan et al., “Fast app launching for mobile devices using predictive user context,” ACM MobiSys 2012. Time delays associated with application launch can be frustrating when a user has to wait many seconds for an application to start and they only want to use the application very briefly. Addressing this issue can improve the performance of a variety of electronic devices such as laptop computers, smartphones, tablets, and wearable computing devices.

### BRIEF SUMMARY OF THE INVENTION

Accordingly, it is an object of the present invention to provide a method that reduces application delays on electronic devices.

In accordance with the present invention, a method is provided for scheduling input/output (I/O) requests for an electronic device. The electronic device has storage media and runs at least one application. Each application interfaces with the storage media through an I/O path. Each application issues I/O requests requiring access to the storage media. The I/O requests include reads from the storage media and writes to the storage media. The I/O requests are ordered in the I/O path such that the reads are assigned a higher priority than the writes. The I/O requests are dispatched from the I/O path to the storage media in accordance with ordering step such that the reads are dispatched before the writes. The scheduling method can also apply concurrency parameters for the electronic device. The concurrency parameters define the optimal number of reads that can be concurrently dispatched to the storage media and the optimal number of writes that can be concurrently dispatched to the storage media. In this scenario, the dispatching step is carried out by concurrently dispatching to the storage media a plurality of reads or a plurality of writes as defined by the concurrency parameters.

### BRIEF DESCRIPTION OF THE DRAWINGS

The summary above, and the following detailed description, will be better understood in view of the drawings that depict details of preferred embodiments.

FIG. 1 is a top-level block diagram of an electronic device illustrating several components thereof in accordance with the prior art;

FIG. 2 depicts the I/O path of an Android-based smartphone that can benefit from use of the present invention;

FIG. 3 is a flow diagram of an input/output (I/O) scheduler implementing read prioritization in accordance with an embodiment of the present invention;

FIG. 4 is a flow diagram of an input/output (I/O) scheduler implementing read prioritization and concurrency optimization in accordance with another embodiment of the present invention;

FIG. 5 is a flow diagram of an input/output (I/O) scheduler implementing read prioritization as a subordinate priority in accordance with another embodiment of the present invention; and

FIG. 6 is a flow diagram of an input/output (I/O) scheduler implementing read prioritization as a subordinate priority and concurrency optimization in accordance with another embodiment of the present invention.

### DETAILED DESCRIPTION OF THE INVENTION

The present invention is an input/output (I/O) scheduling method that can be installed on a variety of electronic devices to include smartphones, laptop computers, tablets, and wearable computing devices. The I/O scheduling method comprises a set of computer-readable and executable instructions installed on a device's computer-readable storage media such that the method's specific operations are performed on the device. The set of computer-readable instructions defining the I/O scheduling method can be provided as an additional scheduling routine on a device, an exclusive scheduling routine on a device, or as a scheduling routine modification that works within the framework of an existing scheduling routine, without departing from the scope of the present invention. In general, the I/O scheduler of the present invention introduces a prioritization scheme that prioritizes read operations (i.e., sequential reads and random reads) ahead of write operations (i.e., sequential writes and random writes). In addition, the I/O scheduler of the present invention can cluster higher-priority read operations or lower-priority write operations for concurrent dispatch in an optimal fashion for the particular device.

Prototype testing of the present invention was implemented on Android-based smartphones across 40 popular applications from four groups (i.e., games, streaming, sensing, and miscellaneous). The I/O scheduler of the present invention reduced launch delays by up to 37.8%, and run-time delays by up to 29.6%, while also reducing power consumption by 6%. Details of the prototype testing and results can be found in “Reducing Smartphone Application Delay Through Read/Write Isolation,” D. T. Nguyen et al., ACM MobiSys '15, May 2015, the entire contents of which are hereby incorporated by reference.

The prototype testing described in the above-cited reference included measurement experiments yielding important smartphone application performance characteristics, several of which are summarized herein. A first performance characteristic is that Android devices spend a significant portion of their CPU active time waiting for storage I/Os to complete. Specifically, the measurement experiments indicated that 40% of the tested devices had I/O wait values (e.g., iowait in an Android device is the percentage of time that the CPUs were idle during which the system had an outstanding disk I/O request, which simply means the time spent waiting for disk I/Os to complete) between 13% and 58% that negatively affect a smartphone's overall application performance resulting in slow response time. The experiments studied slowdown of one type of I/O due to the presence of another type of I/O, and revealed a significant slowdown of reads in the presence of writes. A significant read slowdown can negatively impact an application's performance during cycles when the number of reads dominates the number of I/O requests as is generally the case during the launch of an application. A second performance characteristic of Android devices is that the impact of read/write slowdown on an application's delay can vary depending on the slowdown ratio of a read and a write. In general, the experiments revealed that the slowdown ratio for sequential reads was approximately six times greater than the slowdown ratio for sequential writes, and that the slowdown ratio for random reads was several times greater than the slowdown ratio for random writes. Slowdown ratios are calculated as follows:

Read Slowdown Ratio=(Response time of a read in the presence of a concurrent write)/(Response time of a read when running alone)

Write Slowdown Ratio=(Response time of a write in the presence of a concurrent read)/(Response time of a write when running alone)

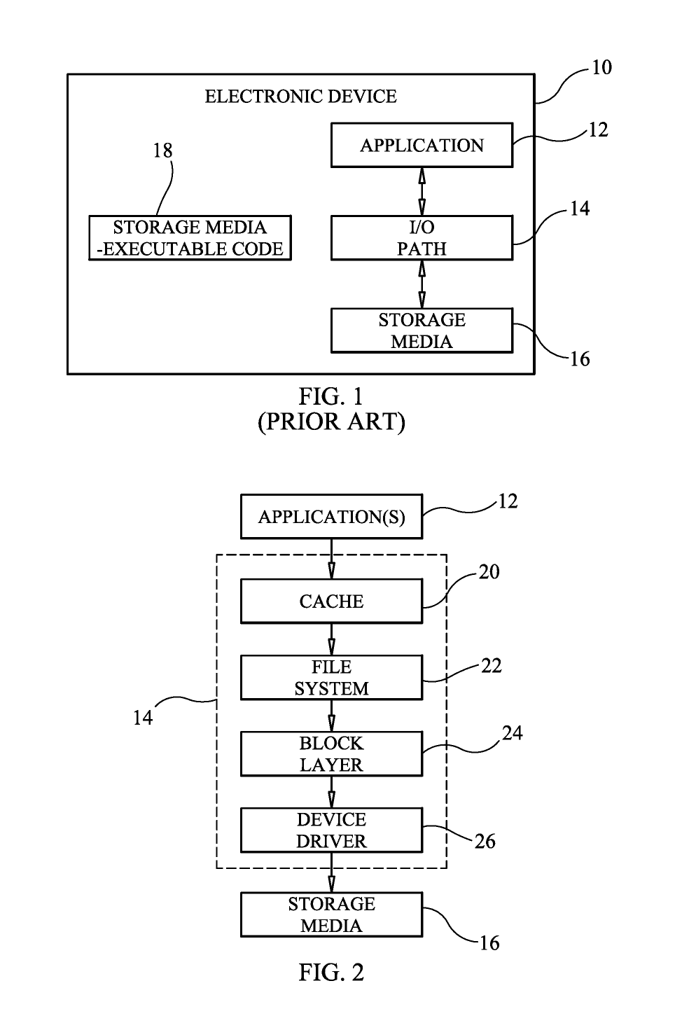

Prior to explaining the present invention, reference will be made to FIG. 1 where a conventional electronic device 10 illustrates three top-level components involved in implementation of the present invention's method. Electronic device 10 is representative of a variety of devices to include smartphones, laptop computers, tablets, wearable computing devices, or any other type of computing device capable of running user applications that issue I/O requests to include reads from the device's storage media and writes to the device's storage media. One or more applications 12 installed on electronic device 10 request access to the device's storage media 16 (that generally includes some type of non-volatile or flash memory) provided on or coupled to electronic device 10 where such requests go through an I/O path 14 on electronic device 10. The types of applications 12, I/O path 14, and storage media 16 are not limitations of the present invention, as they will vary for different types of electronic devices 10. In general, I/O path 14 is a set of hardware and software components that control and execute a variety of I/O activities that originate at application(s) 12 and require access to storage media 16. The I/O activities acted on by the present invention include reads of storage media 16 and writes to storage media 16. Electronic device 10 will typically include additional hardware and software components that support the device's functionality as would be well understood in the art. For example, electronic device 10 will typically include storage media 18 for storing executable computer code such as the executable code for implementing the present invention's I/O scheduler.

By way of an illustrative example, the present invention will be explained for its use with a smartphone running on the Android platform. However, it is to be understood that the present invention can be applied to other operating platforms without departing from the scope of the present invention. Referring now to FIG. 2, the I/O path between Android-based application(s) 12 and the smartphone's storage media 16 (e.g., internal NAND flash memory, an external SD card, and some limited amount of RAM) is illustrated. The components in the I/O path defined between application(s) 12 and storage media 16 are a particular example of the generalized I/O path 14 described above. A brief description of these components will be presented below.

A cache (memory) 20 provides a limited amount of temporary storage for quick/efficient I/O request handling as is well known in the art. The policy governing cache 20 can affect the power used to carry out the I/O activities along the I/O path. Two well-known caching policies are “write back” and “write through”. Write-back is the default approach used in smartphones which in practice means that the device signals I/O completion to the operating system before data has hit the storage media. In contrast, a write-through cache performs all write operations in parallel with data written to the cache and the storage media simultaneously.

A file system 22 defines the various file types used. There are several system types used by smartphone vendors. Each flash partition can be formatted in a different file system type before being properly mounted to given namespaces such as /data, /system, or /cache. Most frequently used file systems are YAFFS2, ext2, ext3, and ext4. YAFFS2 is used, for instance, in HTC Hero of Google Nexus One. Ext4 is employed in the most recent Android smartphones such as Samsung Galaxy or Samsung Nexus S.

A block layer 24 has the primary function of scheduling I/O requests from application(s) 12 and sending them down to a device driver 26. Device driver 26 gets I/O requests (i.e., read requests and write requests) from block layer 24 and does whatever is needed to process them before sending back a notification to block layer 24. The Linux kernels on current Android smartphones offer three scheduling algorithms known as CFQ, Deadline, and Noop. CFQ (Complete Fair Queuing) attempts to distribute available I/O bandwidth equally among all I/O requests. The requests are placed into per-process queues where each of the queues gets a time slice allocated thereto. The Deadline algorithm attempts to guarantee a start time for a process. The queues are sorted by expiration time of processes. Noop inserts incoming I/Os into a FIFO fashion queue and implements request merging. However, each of these I/O scheduling routines introduces application delays that hamper user productivity.

Storage media 16 on smartphones, laptops, tablets, etc., is typically some type of flash storage. Flash storage differs significantly from conventional rotating-disk storage. While rotating disks suffer from the seek time bottleneck, flash storage devices do not. Although providing superior performance compared to conventional storage, flash storage does have its own limitations. For instance, the erase-before-write limitation requires an erase operation before overwriting a location leading to a substantial read/write speed discrepancy, i.e., writes take longer to complete than reads.

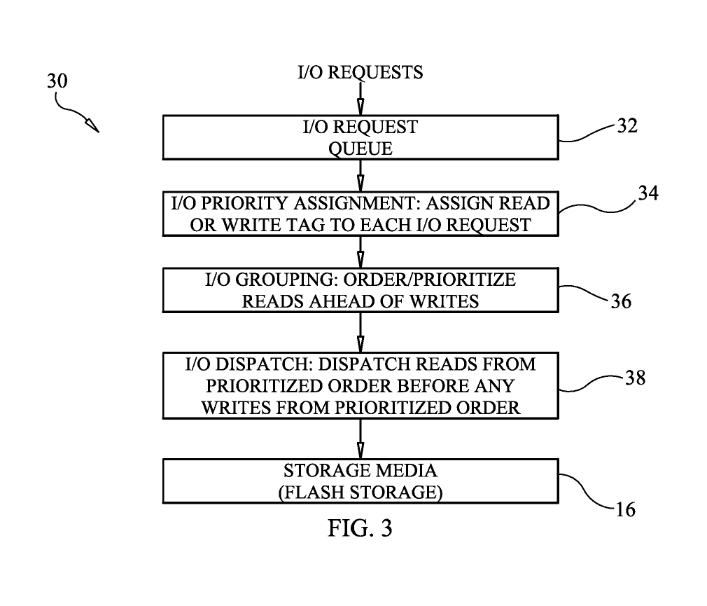

As with existing I/O scheduling routines, the I/O scheduler of the present invention is implemented/run in the kernel space at block layer 24. Several embodiments of the present invention's I/O scheduler will be explained with the aid of FIGS. 3-6 where the scheduler's process steps are presented in flow diagrams. Referring first to FIG. 3, an I/O scheduler 30 illustrates the essential processing steps associated with the novel approach to I/O scheduling in accordance with the present invention. As mentioned above, I/O requests issued by a device's application are temporarily stored in an I/O request queue 32. For purpose of the present invention, the I/O requests are either a request to read from storage media 16 or a request to write to storage media 16. An I/O priority assignment block 34 assigns each I/O request in queue 32 with a tag or identifier to indicate that the I/O request is either a read or a write. An I/O grouping block 36 places the tagged I/O requests in order using the read and write tags. More specifically, I/O grouping block 36 prioritizes the I/O requests with all reads being given a higher priority than writes. An I/O dispatching block 38 dispatches the I/O requests from grouping block 36 to storage media 16 in accordance with the prioritized ordering of the I/O requests. That is, dispatch block 38 gets/dispatches all reads before writes so that writes will only be dispatched after all reads have been dispatched. Note that write starvation is avoided since application processes are allocated a time slice (e.g., a Linux scheduler default is 100 ms) occurring on a layer above that of the I/O scheduler. Since application launches include significantly more read I/O requests than write I/O requests, and since reads from flash storage occur much faster than writes to flash storage, the I/O scheduler of the present invention reduces application delay occurring during application launch and run-time.

Another property that can affect application delay is concurrency where a plurality of read requests or a plurality of write requests are dispatched simultaneously to a device's storage media. That is, concurrency is an approach to speeding up an application's response time by issuing I/O requests concurrently. Since optimal concurrency (i.e., an optimal number of concurrent read requests or an optimal number of concurrent write requests) can be dependent on hardware characteristics, optimal concurrency parameters will vary from device to device. A device's optimal concurrency parameters can be included in an I/O scheduler of the present invention to further reduce application delay. To determine a device's optimal concurrency parameters, the device needs to be benchmarked in terms of the device's concurrency characteristics. Such characteristics include the following four concurrency parameters: the optimal number of concurrent sequential reads, the optimal number of concurrent sequential writes, the optimal number of concurrent random reads, and the optimal number of concurrent random writes.

To benchmark a device in terms of its optimal concurrency parameters, a Linux tester known as the fio tool can be invoked during installation of the present invention's I/O scheduler. For details on the fio tool, see J. Axboe, “fio: Flexible I/O tester,” http://linux.die.net/man/1/fio, 2014. Briefly, the fio tool issues reads and writes, and calculates the speedup of concurrent I/Os over serial ones to determine the concurrency parameters associated with optimal speedup. These concurrency parameters can then be incorporated in an I/O scheduler of the present invention and used to complete the I/O requests. This assures robustness of the present invention as it can be adapted to different characteristics of the flash storage in any particular device.

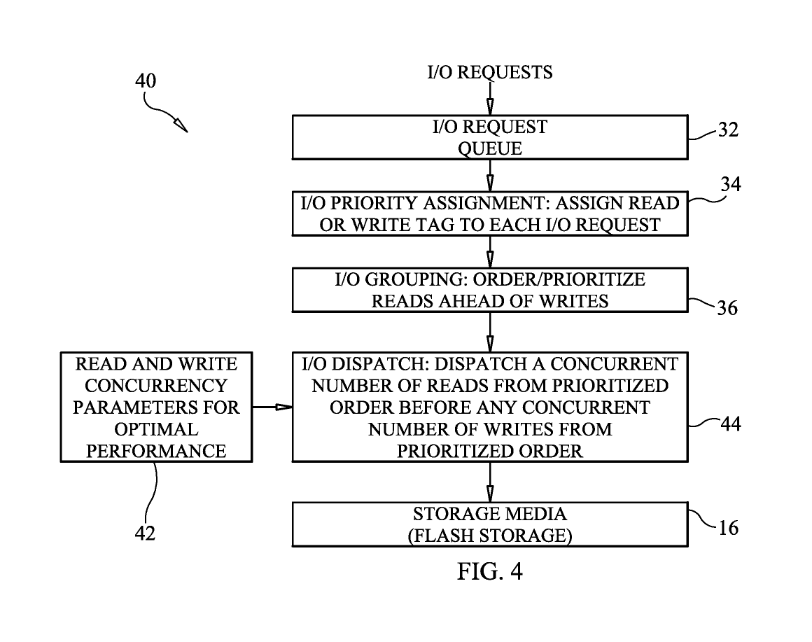

Referring now to FIG. 4, another embodiment of an I/O scheduler in accordance with the present invention is shown and is referenced generally by numeral 40. I/O scheduler 40 is similar to I/O scheduler 30 described above, but also includes use of the device's optimal read/write concurrency parameters to control the dispatching of the ordered/prioritized I/O requests. More specifically, I/O scheduler 40 includes I/O request queue 32, I/O priority assignment block 34, and I/O grouping block 36 as previously described. In addition, I/O scheduler 40 provides read and write concurrency parameters 42 to an I/O dispatch block 44. Parameters 42 are the pre-determined (e.g., determined during installation of the I/O scheduler on a particular device) concurrency parameters that define the optimal number of each of concurrent sequential reads, concurrent random reads, concurrent sequential writes, and concurrent random writes for the particular device. I/O dispatch block 44 uses parameters 42 to dispatch to storage media 16 the optimal number of concurrent reads/writes from the prioritized order defined by grouping block 36.

As mentioned above, the I/O scheduler of the present invention can be configured to work with the framework of known scheduling routines. For example, the CFQ scheduler (e.g., see J. Axboe in “Linux Block IO—Present and Future,” Ottawa Linux Symposium, 2004) is widely used as the default I/O scheduler in Android smartphones. This scheduler attempts to distribute available I/O bandwidth equally among all I/O requests, but is “blind” to the request's read or write status. There are two priority levels defined in the CFQ framework: one is the class, and the other is the priority within the class. There are three classes defined in the CFQ framework: real-time, best effort, and idle. Real-time class requests have the highest priority, followed by the best effort class for which storage access requests are granted only when there is no real-time request left. The idle class is given a storage access only when the storage is idle. Within the real-time and best effort classes, there are eight additional priorities (i.e., ranked 0 for highest to 7 for lowest). Requests are placed into queues where each of the queues gets a time slice allocated to it. There are 8 queues in the real-time class, 8 queues in the best effort class, and 1 queue in the idle class.

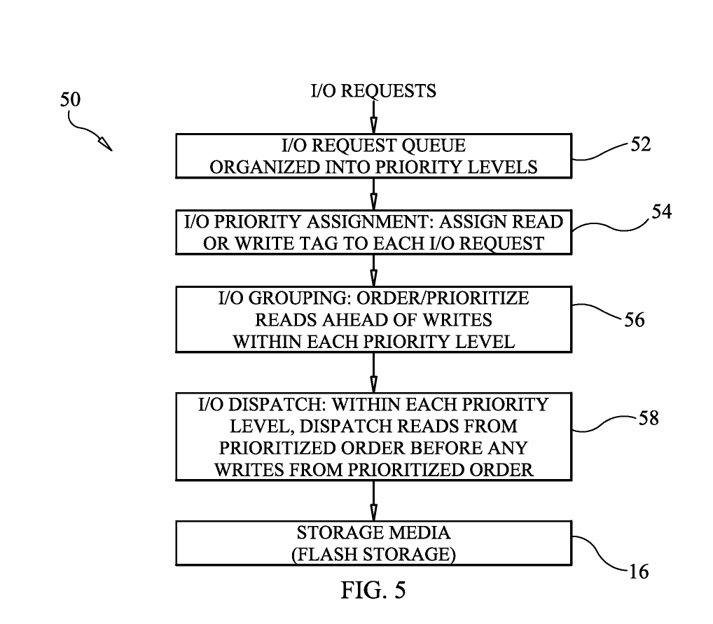

In general, the CFQ scheduler is representative of a scheduler that has one or more priority levels defined thereby in order to provide a prioritized hierarchy for I/O requests. The I/O scheduler of the present invention can be adapted to work within this type of scheduling framework by adding another subordinate priority level defined by the above-described read-over-write priority of the present invention. Accordingly, FIG. 5 illustrates an I/O scheduler 50 having an I/O request queue 52 that is organized or divided into a plurality of queues based on a priority scheme. For example, the CFQ scheduler defines three request queues such as those used by CFQ, i.e., a real-time request queue having the highest priority, a best effort request queue having the next highest priority, and an idle request queue having the lowest priority. An I/O priority assignment block 54 assigns each I/O request in queue 52 with a tag or identifier to indicate that the I/O request is either a read or a write. An I/O grouping block 56 orders, within each I/O request queue priority level, the tagged I/O requests such that all reads are given a higher priority than all writes within a priority level. For example, using the CFQ framework, grouping block 56 would order all reads ahead of writes in the real-time priority level, order all reads ahead of writes in the best effort priority level, and all reads ahead of writes in the idle priority level. An I/O dispatching block 58 dispatches, within each priority level, the ordered I/O requests from block 56 to storage media 16. More specifically, block 58 dispatches all reads and then all writes from the highest priority level (defined at the I/O request queue) before moving on to the next/lower priority level where all reads and then all writes are dispatched. For example, all reads and then all writes would be dispatched from the CFQ's real-time priority level prior to dispatching all reads and then all writes from the CFQ's best effort priority level.

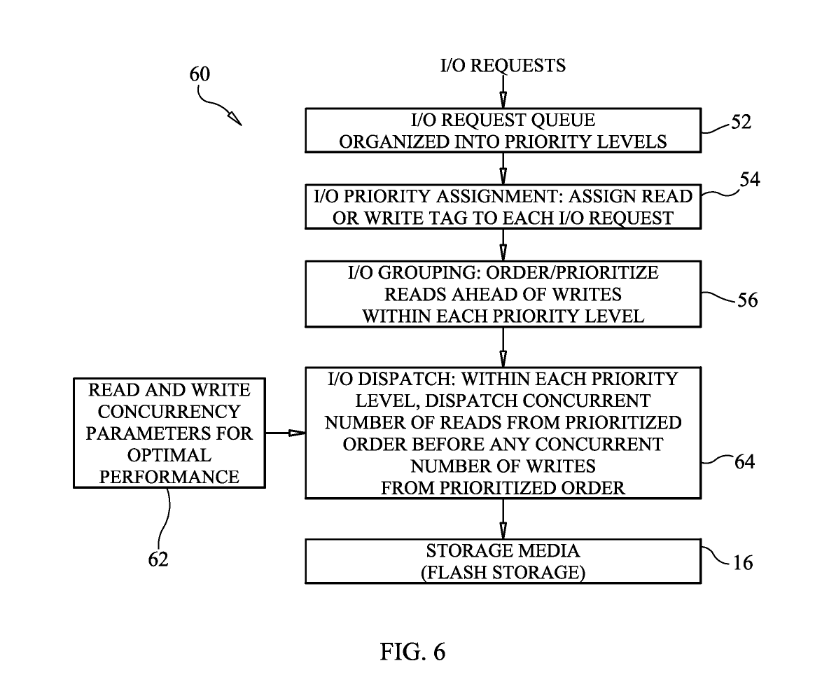

Referring now to FIG. 6, another embodiment of an I/O scheduler in accordance with the present invention is shown and is referenced generally by numeral 60. I/O scheduler 60 is similar to I/O scheduler 50 described above, but also includes use of the device's optimal read/write concurrency parameters to control dispatching of the ordered/prioritized I/O requests within each priority level. More specifically, I/O scheduler 60 includes I/O request queue 52, I/O priority assignment block 54, and I/O grouping block 56 as previously described. In addition, I/O scheduler 60 provides read and write concurrency parameters 62 to an I/O dispatch block 64. Parameters 62 are identical to parameters 42 described above and, therefore, define the optimal number of concurrent sequential reads, concurrent random reads, concurrent sequential writes, and concurrent random writes for the particular device. I/O dispatch block 64 uses parameters 62 to dispatch to storage media 16 the optimal number of concurrent reads/writes from the prioritized order in each of the priority levels and in accordance with the hierarchy of the priority levels.

The advantages of the present invention are numerous. Application delays in electronic devices such as smartphones, etc., are reduced by prioritizing reads over writes, and grouping them based on assigned priorities. Due to the read/write discrepancy nature of typically-used flash storage where reads take much less time to complete than writes, the read-preference reordering used by the present invention does not introduce a major delay to write requests. The approach can be further enhanced by incorporating optimized concurrency parameters into the dispatch operation.

The present invention's reordering scheme does not affect correctness and semantics of write barriers. As disclosed by P. Reisner et al. in “Replicated storage with shared disk semantics,” Linux System Technology, 2005, write barriers are essential for consistency of many file systems and are maintained at the file system layer which is above the I/O scheduler. Therefore, requests issued to the present invention's I/O scheduler can be reordered without affecting write barrier correctness.

The present invention need not change a device's dispatch process as it simply applies a subordinate priority level to organize the dispatch queue in favor of read requests. The dispatch queue can be divided into sections identifying priority levels where each section is organized with the present invention's subordinate priority such that reads precede writes within “parent” priority levels.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A method of scheduling input/output (I/O) requests for an electronic device, comprising the steps of:
providing an electronic device having storage media and running at least one application, wherein each said application interfaces with said storage media through an I/O path, each said application issuing I/O requests requiring access to said storage media, and wherein said I/O requests include reads from said storage media and writes to said storage media;
ordering said I/O requests in said I/O path wherein said reads are assigned a higher priority than said writes; and
dispatching said I/O requests from said I/O path to said storage media in accordance with said step of ordering wherein said reads are dispatched before said writes.

2. A method according to claim 1, wherein said I/O path includes an I/O request queue divided into multiple priority levels, said method further comprising the step of assigning each of said I/O requests to one of said priority levels in said I/O request queue prior to said step of ordering;
wherein said step of ordering comprises the step of ordering said I/O requests within each of said priority levels, wherein said reads are assigned a higher priority than said writes in each of said priority levels of said I/O request queue; and
wherein said step of dispatching is completed at a higher one of said priority levels prior to being completed at a lower one of said priority levels.

3. A method according to claim 1, further comprising the steps of:
providing concurrency parameters for said electronic device, said concurrency parameters defining an optimal number of said reads that can be concurrently dispatched to said storage media and an optimal number of writes that can be concurrently dispatched to said storage media; and
wherein said step of dispatching comprises the step of concurrently dispatching to said storage media one of a plurality of said reads as defined by said concurrency parameters and a plurality of said writes as defined by said concurrency parameters.

4. A method according to claim 2, further comprising the steps of:
providing concurrency parameters for said electronic device, said concurrency parameters defining an optimal number of said reads that can be concurrently dispatched to said storage media and an optimal number of writes that can be concurrently dispatched to said storage media; and
wherein said step of dispatching for each of said priority levels comprises the step of concurrently dispatching to said storage media one of a plurality of said reads as defined by said concurrency parameters and a plurality of said writes as defined by said concurrency parameters.

5. A method of scheduling input/output (I/O) requests for an electronic device, comprising the steps of:
providing an electronic device having flash storage media and running at least one application, wherein each said application interfaces with said flash storage media through an I/O path that includes a block layer, each said application issuing I/O requests requiring access to said flash storage media, and wherein said I/O requests include reads from said flash storage media and writes to said flash storage media;
ordering said I/O requests in said block layer wherein said reads are assigned a higher priority than said writes; and
dispatching said I/O requests from said block layer to said flash storage media in accordance with said step of ordering wherein said reads are dispatched before said writes.

6. A method according to claim 5, wherein said block layer includes an I/O request queue divided into multiple priority levels, said method further comprising the step of assigning each of said I/O requests to one of said priority levels in said I/O request queue prior to said step of ordering;
wherein said step of ordering comprises the step of ordering said I/O requests within each of said priority levels, wherein said reads are assigned a higher priority than said writes in each of said priority levels of said I/O request queue; and
wherein said step of dispatching is completed at a higher one of said priority levels prior to being completed at a lower one of said priority levels.

7. A method according to claim 5, further comprising the steps of:
providing concurrency parameters for said electronic device, said concurrency parameters defining an optimal number of said reads that can be concurrently dispatched to said flash storage media and an optimal number of writes that can be concurrently dispatched to said flash storage media; and
wherein said step of dispatching comprises the step of concurrently dispatching to said flash storage media one of a plurality of said reads as defined by said concurrency parameters and a plurality of said writes as defined by said concurrency parameters.

8. A method according to claim 6, further comprising the steps of:
providing concurrency parameters for said electronic device, said concurrency parameters defining an optimal number of said reads that can be concurrently dispatched to said flash storage media and an optimal number of writes that can be concurrently dispatched to said flash storage media; and
wherein said step of dispatching for each of said priority levels comprises the step of concurrently dispatching to said flash storage media one of a plurality of said reads as defined by said concurrency parameters and a plurality of said writes as defined by said concurrency parameters.

9. A computer-readable storage device having instructions stored that, when executed by a computing device having flash storage media and running at least one application issuing I/O requests requiring reads from and writes to said flash storage media, cause the computing device to perform operations comprising:
interfacing with said flash storage media through an I/O path that includes a block layer;
ordering said I/O requests in said block layer wherein said reads are assigned a higher priority than said writes; and
dispatching said I/O requests from said block layer to said flash storage media in accordance with said step of ordering wherein said reads are dispatched before said writes.

10. A computer-readable storage device as in claim 9, wherein said block layer includes an I/O request queue divided into multiple priority levels, wherein said computer-readable storage device has additional instructions stored that, when executed by the computing device result in operations comprising:
assigning each of said I/O requests to one of said priority levels in said I/O request queue prior to said step of ordering;
wherein said step of ordering comprises the step of ordering said I/O requests within each of said priority levels, wherein said reads are assigned a higher priority than said writes in each of said priority levels of said I/O request queue; and
wherein said step of dispatching is completed at a higher one of said priority levels prior to being completed at a lower one of said priority levels.

11. A computer-readable storage device as in claim 9, wherein said computer-readable storage device has additional instructions stored that, when executed by the computing device result in operations comprising:
defining concurrency parameters for said computing device, said concurrency parameters defining an optimal number of said reads that can be concurrently dispatched to said flash storage media and an optimal number of writes that can be concurrently dispatched to said flash storage media; and
wherein said step of dispatching comprises the step of concurrently dispatching to said flash storage media one of a plurality of said reads as defined by said concurrency parameters and a plurality of said writes as defined by said concurrency parameters.

12. A computer-readable storage device as in claim 10, wherein said computer-readable storage device has additional instructions stored that, when executed by the computing device result in operations comprising:
defining concurrency parameters for said computing device, said concurrency parameters defining an optimal number of said reads that can be concurrently dispatched to said flash storage media and an optimal number of writes that can be concurrently dispatched to said flash storage media; and
wherein said step of dispatching for each of said priority levels comprises the step of concurrently dispatching to said flash storage media one of a plurality of said reads as defined by said concurrency parameters and a plurality of said writes as defined by said concurrency parameters.
